(19) United States
(12) Patent Application Publication
(10) Pub. No.: US 2025/0061541 A1
(43) Pub. Date: Feb. 20, 2025

(54) VIDEO SUPER-RESOLUTION METHOD AND DEVICE

(71) Applicant: Beijing Bytedance Network Technology Co., Ltd., Beijing (CN)

(72) Inventor: Hang DONG, Beijing (CN)

(21) Appl. No.: 18/725,722

(22) PCT Filed: Mar. 16, 2023
(86) PCT No.: PCT/CN2023/081794

§ 371 Date: Jun. 28, 2024

(30) Foreign Application Priority Data
Mar. 17, 2022 (CN) 202210265574.6

(51) Int. Cl. G06T 3/4053; G06T 3/4046; G06T 7/246

(52) U.S. Cl. CPC G06T 3/4053; G06T 3/4046; G06T 7/246; G06T 2207/10016; G06T 2207/20021; G06T 2207/20084

(57) ABSTRACT

Embodiments of the present disclosure relate to the technical field of image processing, and provide a video super-resolution method and device. The method includes: decomposing a target image frame of a video to be super-resolved into a plurality of image blocks; obtaining a super-resolution feature of the target image frame according to the plurality of image blocks and image blocks obtained by decomposing the other image frames in the video to be super-resolved; and obtaining, according to the super-resolution feature of the target image frame, a super-resolution image frame corresponding to the target image frame.

The present disclosure is based on and claims the priority to the Chinese application No. 202210265574.6 filed on Mar. 17, 2022, the disclosure of which is incorporated by reference herein in its entirety.

### TECHNICAL FIELD

The present disclosure relates to the technical field of image processing, and in particular, to a video super-resolution method and device.

### BACKGROUND

Super-resolution technology for video, also called as video super-resolution technology, is a technology of recovering a high-resolution video from a low-resolution video. Since a video super-resolution business has become a key business in video quality enhancement at present, the video super-resolution technology is one of research hotspots in the current image processing field.

In recent years, with the development of deep learning technology, in a video super-resolution network model based on a deep learning neural network, many breakthroughs have been achieved, comprising better super-resolution effect and better real-time performance. At present, mainstream video super-resolution network models all utilize the fact that most image frames in a video are in motion, so that when super-resolution is performed on each image frame in the video, its neighborhood image frames all can provide a large amount of time domain information, for the video super-resolution network model to perform super-resolution on a current image frame.

### SUMMARY

In a first aspect, an embodiment of the present disclosure provides a video super-resolution method, comprising:
decomposing a target image frame of a video to be super-resolved into a plurality of image blocks;
obtaining a super-resolution feature of the target image frame according to the plurality of image blocks and image blocks obtained by decomposing other image frames in the video to be super-resolved; and
obtaining a super-resolution image frame corresponding to the target image frame according to the super-resolution feature of the target image frame.

In a second aspect, an embodiment of the present disclosure provides a video super-resolution apparatus, comprising:
an image decomposition module, configured to decompose a target image frame of a video to be super-resolved into a plurality of image blocks;
a feature obtaining module, configured to obtain a super-resolution feature of the target image frame according to the plurality of image blocks and image blocks obtained by decomposing other image frames in the video to be super-resolved; and
an image generation module, configured to obtain a super-resolution image frame corresponding to the target image frame according to the super-resolution feature of the target image frame.

In a third aspect, an embodiment of the present disclosure provides an electronic device, comprising: a memory and a processor, the memory being configured to store a computer program, and the processor being configured to, when calling the computer program, cause the electronic device to implement the video super-resolution method according to the first aspect or any of optional implementations of the first aspect.

In a fourth aspect, an embodiment of the present disclosure provides a computer-readable storage medium which, when executed by a computing device, causes the computing device to implement the video super-resolution method according to the first aspect or any of optional implementations of the first aspect.

In a fifth aspect, an embodiment of the present disclosure provides a computer program product which, when run on a computer, causes the computer to implement the video super-resolution method according to the first aspect or any of optional implementations of the first aspect.

### BRIEF DESCRIPTION OF THE DRAWINGS

The accompanying drawings herein, which are incorporated in and constitute a part of this specification, illustrate embodiments consistent with the present disclosure and, together with the description, serve to explain the principles of the present disclosure.

In order to more clearly illustrate technical solutions in the embodiments of the present disclosure or the related art, the drawings that need to be used in the description of the embodiments or the related art will be briefly described below, and it is obvious that for one of ordinary skill in the art, other drawings can be obtained without paying creative labor.

FIG. 1 is a first flow diagram of a video super-resolution method according to an embodiment of the present disclosure;

FIG. 2 is a schematic diagram of image blocks obtained by decomposing an image frame according to an embodiment of the present disclosure;

FIG. 3 is a second flow diagram of a video super-resolution method according to an embodiment of the present disclosure;

FIG. 4 is a third flow diagram of a video super-resolution method according to an embodiment of the present disclosure;

FIG. 5 is a schematic structural diagram of a video super-resolution network according to an embodiment of the present disclosure;

FIG. 6 is a second flow diagram of a video super-resolution method according to an embodiment of the present disclosure;

FIG. 7 is a first schematic diagram of an image block sequence according to an embodiment of the present disclosure;

FIG. 8 is a first schematic diagram of a backward feature obtaining module according to an embodiment of the present disclosure;

FIG. 9 is a second schematic diagram of a backward feature obtaining module according to an embodiment of the present disclosure;

FIG. 10 is a third flow diagram of a video super-resolution method according to an embodiment of the present disclosure;

FIG. 11 is a second schematic diagram of an image block sequence according to an embodiment of the present disclosure;

FIG. 12 is a first schematic diagram of a forward feature obtaining module according to an embodiment of the present disclosure;

FIG. 13 is a second schematic diagram of a forward feature obtaining module according to an embodiment of the present disclosure;

FIG. 14 is a second schematic structural diagram of a video super-resolution network according to an embodiment of the present disclosure;

FIG. 15 is a schematic diagram of a video super-resolution apparatus according to an embodiment of the present disclosure;

FIG. 16 is a schematic diagram of a video super-resolution apparatus according to an embodiment of the present disclosure;

FIG. 17 is a schematic hardware structural diagram of an electronic device according to an embodiment of the present disclosure.

### DETAILED DESCRIPTION

In order that the above objectives, features and advantages of the present disclosure may be more clearly understood, solutions of the present disclosure will be further described below. It should be noted that, without conflict, the embodiments of the present disclosure and features in the embodiments may be combined with each other.

In the following description, numerous specific details are set forth in order to provide a thorough understanding of the present disclosure, but the present disclosure may be implemented in other way than those described herein; and it is obvious that the embodiments in the description are only a part of the embodiments of the present disclosure, rather than all of them.

It should be noted that, for the convenience of a clear description of the technical solutions of the embodiments of the present disclosure, in the embodiments of the present disclosure, same or similar items with basically same functions and effects are distinguished by using words such as “first”, “second”, etc., and those skilled in the art can understand that the words such as “first”, “second”, etc. do not limit the quantity and execution order. For example: a first feature image set and a second feature image set are only used for distinguishing different feature image sets, rather than limiting the order of the feature image sets.

In the embodiments of the present disclosure, words such as “exemplary” or “for example” are used for indicating an example, instance, or illustration. Any embodiment or design solution described as “exemplary” or “for example” in the embodiments of the present disclosure should not be construed as more preferred or advantageous than another embodiment or design solution. Exactly, the use of the word “exemplary” or “for example” is intended to present relevant concepts in a specific manner. Furthermore, in the description of the embodiments of the present disclosure, the meaning of “a plurality” means two or more unless otherwise specified.

In the related art, when super-resolution is performed on each image frame in a video, its neighborhood image frames all can provide a large amount of time domain information, for a video super-resolution network model to perform super-resolution on a current image frame. However, in some videos, some areas are always stationary objects or backgrounds, and when super-resolution is performed on such videos, since the stationary objects or backgrounds will cause motion information estimation errors, and the errors will accumulate during information transfer, the errors gradually increase; meanwhile, redundant information of these objects or backgrounds will also cause effective time domain information of image frames spaced farer away to be gradually replaced in the information transfer, so that the network cannot effectively utilize the time domain information of the image frames spaced farer away. In summary, when stationary objects or backgrounds exist in a video, the video super-resolution network model is very likely to fail to obtain enough time domain information for super-resolution on an image frame, resulting in a very unsatisfactory video super-resolution effect.

An embodiment of the present disclosure provides a video super-resolution method for improving the video super-resolution effect.

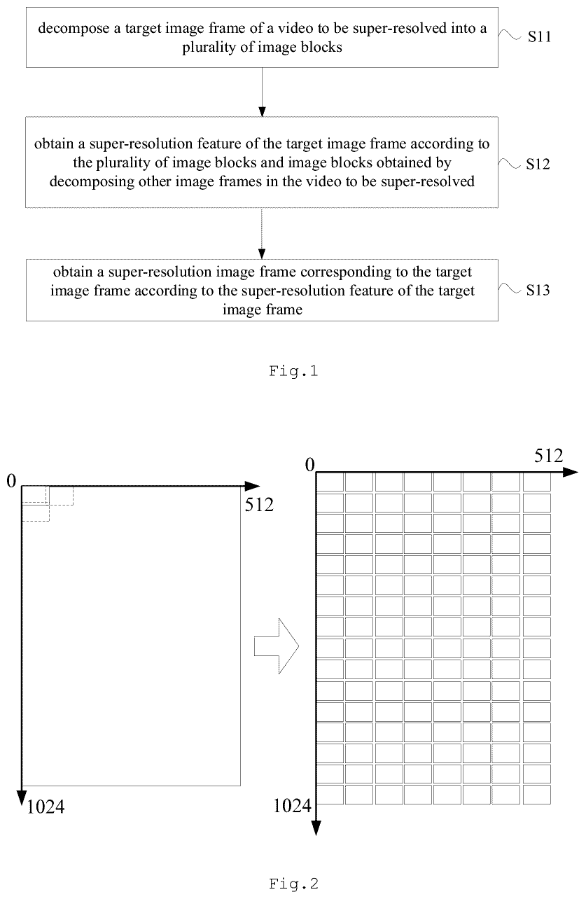

Referring to the flow diagram shown in FIG. 1, a video super-resolution method provided in an embodiment of the present disclosure comprises:
S11, decomposing a target image frame of a video to be super-resolved into a plurality of image blocks.

In some embodiments, the implementation of the above step S11 (decomposing a target image frame of a video to be super-resolved into a plurality of image blocks) may comprise: by means of a sampling window with a size of one image block and a stride of a preset value, sampling positions of the target image frame from a first pixel of the target image frame, and taking each sampling area of the sampling window as one image block, thereby decomposing the target image frame into the plurality of image blocks.

Exemplarily, referring to FIG. 2, a target image frame of a video to be super-resolved comprises 1024*512 pixels, and when a sampling window has a size of 72*72 and a stride of 64, the target image frame of the video to be super-resolved can be decomposed into 16*8 image blocks, each comprising 72*72 pixels, and adjacent image blocks having an overlapping area therebetween, which has a width of 8 pixel areas.

The method further comprises S12, obtaining a super-resolution feature of the target image frame according to the plurality of image blocks and image blocks obtained by decomposing other image frames in the video to be super-resolved.

In some embodiments, the above step S12 (obtaining a super-resolution feature of the target image frame according to the plurality of image blocks and image blocks obtained by decomposing other image frames in the video to be super-resolved) comprises: according to the image blocks obtained by decomposing other image frames in the video to be super-resolved, respectively obtaining a super-resolution feature of each image block in the plurality of image blocks, and merging the super-resolution feature of each image block in the plurality of image blocks, to obtain the super-resolution feature of the target image frame.

For example, when a video to be super-resolved comprises N image frames, a target image frame is a t-th image frame of the video to be super-resolved, and each image frame of the video to be super-resolved is decomposed into N image blocks, image blocks obtained by decomposing other image frames in the video to be super-resolved comprises: image blocks B₁¹, B₁², . . . , B₁ⁿ, . . . , Bₜ₋₁¹, Bₜ₋₁², . . . , Bₜ₋₁^{N}, Bₜ₊₁¹, Bₜ₊₁², B, Bₙ¹, Bₙ², . . . , and Bₙ^{N}; and image blocks obtained by decomposing the target image frame of the video to be super-resolved comprises image blocks Bₜ¹, Bₜ², . . . and Bₜ^{N}, wherein the image block B, represents an i -th image block obtained by decomposing a j-th video frame of the video to be super-resolved. Therefore, according to the image blocks B₁¹, B₁², . . . , B₁^{N}, . . . , Bₜ₋₁¹, Bₜ₋₁², . . . ,Bₜ₋₁^{N}, Bₜ₊₁¹, Bₜ₊₁², . . . , B¹ₙ, B²ₙ, . . . , and Bₙ^{N}, super-resolution features of the image blocks Bₜ¹, Bₜ², . . . , and Bₜ^{N} can be respectively obtained, and then the super-resolution features of the image blocks Bₜ¹, Bₜ², . . . and Bₜ^{N} are merged to obtain a super-resolution feature of the t-th image frame.

The method further comprises S13, obtaining a super-resolution image frame corresponding to the target image frame according to the super-resolution feature of the target image frame.

In some embodiments, the above step S13 (obtaining a super-resolution image frame corresponding to the target image frame according to the super-resolution feature of the target image frame) comprises:
performing addition fusing on the super-resolution feature of the target image frame and a feature of the target image frame to obtain the super-resolution image frame corresponding to the target image frame.

In the video super-resolution method provided in the embodiment of the present disclosure, when super-resolution is performed on a target image frame image of a video to be super-resolved, the target image frame of the video to be super-resolved is decomposed into a plurality of image blocks first, then a super-resolution feature of the target image frame is obtained according to the plurality of image blocks and image blocks obtained by decomposing other image frames in the video to be super-resolved, and finally, a super-resolution image frame corresponding to the target image frame is obtained according to the super-resolution feature of the target image frame. Compared with the super-resolution of an image frame depending on time domain information provided by adjacent image frames in the related art, according to the super-resolution method provided in the embodiment of the present disclosure, when a target image frame of a video to be super-resolved is super-resolved, by means of image blocks obtained by decomposing all the other image frames than the target video frame in the video to be super-resolved, time domain information can be provided for image blocks obtained by decomposing the target video frame, and then a super-resolution feature of the target image frame is obtained. Therefore, even if the video to be super-resolved has therein stationary objects or backgrounds in adjacent image frames, the embodiment of the present disclosure can provide sufficient time domain information for the image blocks of the target video frame by using non-adjacent image frames, and then provide sufficient time domain information for the target video frame, so that the embodiment of the present disclosure can improve the video super-resolution effect.

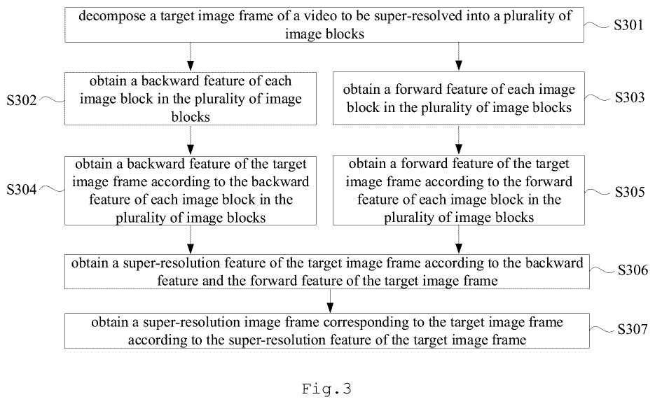

As an extension and refinement to the above embodiment, an embodiment of the present disclosure provides another video super-resolution method, referring to FIG. 3, comprising:
S301, decomposing a target image frame of a video to be super-resolved into a plurality of image blocks;

The method further comprises S302, obtaining a backward feature of each image block in the plurality of image blocks;

A backward feature of any image block is a feature of an image block corresponding to the image block in image blocks obtained by decomposing image frames located after the target image frame in the video to be super-resolved.

The method further comprises S303, obtaining a forward feature of each image block in the plurality of image blocks.

A forward feature of any image block is a feature of an image block corresponding to the image block in image blocks obtained by decomposing image frames located before the target image frame in the video to be super-resolved.

The method further comprises S304, obtaining a backward feature of the target image frame according to the backward feature of each image block in the plurality of image blocks.

That is, the backward feature of each image block in the plurality of image blocks is fused to obtain the backward feature of the target image frame.

The method further comprises S305, obtaining a forward feature of the target image frame according to the forward feature of each image block in the plurality of image blocks.

That is, the forward feature of each image block in the plurality of image blocks is fused to obtain the forward feature of the target image frame.

The method further comprises S306, obtaining a super-resolution feature of the target image frame according to the backward feature and the forward feature of the target image frame.

As an optional implementation of the embodiment of the present disclosure, the above step S306 (obtaining a super-resolution feature of the target image frame according to the backward feature and the forward feature of the target image frame) comprises the following steps a and b:
step a, merging the backward feature and the forward feature of the target image frame to obtain a merged feature of the target image frame.

Exemplarily, the backward feature of the target image frame and the forward feature of the target image frame can be concatenated in a channel dimension, thereby obtaining a merged feature of the target image frame.

The method comprises Step b, up-sampling the merged feature of the target image frame to obtain the super-resolution feature of the target image frame.

It should be noted that, in the above embodiment, as an example, it is possible to merge the backward feature and the forward feature of the target image frame first and then up-sample the merged feature, to obtain the super-resolution feature of the target image frame, but it is also possible to respectively up-sample the backward feature and the forward feature of the target image frame first and then merge the up-sampled results, to obtain the super-resolution feature of the target image frame.

The method further comprises S307, obtaining a super-resolution image frame corresponding to the target image frame according to the super-resolution feature of the target image frame.

The implementation principle and technical effect of the video super-resolution method provided in this embodiment are similar to those of the video super-resolution method shown in FIG. 1, and thus are not repeated here.

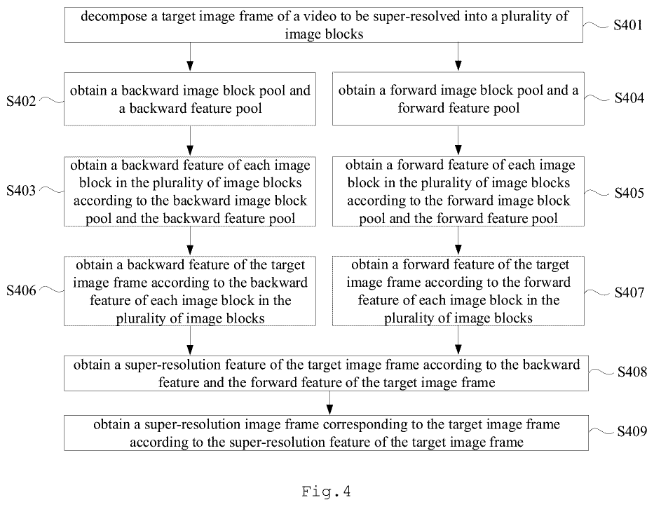

As a further extension and refinement of the above embodiment, an embodiment of the present disclosure provides another video super-resolution method, referring to FIG. 4, comprising: S401, decomposing a target image frame of a video to be super-resolved into a plurality of image blocks; and S402, obtaining a backward image block pool and a backward feature pool.

The backward image block pool comprises a backward image block corresponding to each image block in the plurality of image blocks; a backward image block corresponding to any image block is an image block selected from image blocks obtained by decomposing image frames located after the target image frame in the video to be super-resolved based on a preset selection rule; and the backward feature pool comprises a feature of each backward image block in the backward image block pool.

That is, when the target image frame is decomposed into N image blocks, the backward image block pool comprises N backward image blocks, and the backward feature pool comprises N features; the N backward image blocks are in a one-to-one correspondence with the plurality of image blocks, and the N features in the backward feature pool respectively are features of the N backward image blocks.

In some embodiments, when the target image frame is a t-th image frame of the video to be super-resolved, for an image block Bt in the plurality of image blocks, an implementation of selecting a backward image block corresponding to the image block Bt from image blocks obtained by decomposing a (t+1) -th image frame to a last image frame of the video to be super-resolved based on the preset selection rule comprises: firstly, determining each image block with a same position as the image block Bₜⁱ in the image blocks obtained from decomposing the (t+1)-th image frame to the last image frame of the video to be super-resolved, to obtain a first image block set {Bₜ₊₁ⁱ, Bₜ₊₂ⁱ, . . . , B_{M}ⁱ}, and then selecting, fromthe first image block set {Bₜ₊₁ⁱ, Bₜ₊₂ⁱ, . . . , B_{M}ⁱ, an image block capable of providing most effective time domain information for the image block Bₜⁱ as the backward image block corresponding to the image block Bₜⁱ.

The method further comprises S403, obtaining a backward feature of each image block in the plurality of image blocks according to the backward image block pool and the backward feature pool.

The method further comprises S404, obtaining a forward image block pool and a forward feature pool.

The forward image block pool comprises a forward image block corresponding to each image block in the plurality of image blocks; a forward image block corresponding to any image block is an image block selected from image blocks obtained by decomposing image frames located before the target image frame in the video to be super-resolved based on the preset selection rule; and the forward feature pool comprises a feature of each forward image block in the forward image block pool.

That is, when the target image frame is decomposed into N image blocks, the forward image block pool comprises N forward image blocks, and the forward feature pool comprises N features; the N forward image blocks are in a one-to-one correspondence with the plurality of image blocks, and the N features in the forward feature pool respectively are features of the N forward image blocks.

In some embodiments, for an image block Bt in the plurality of image blocks, an implementation of selecting a forward image block corresponding to the image block Bₜ^{j} from image blocks obtained by decomposing a 1st image frame to a (t−1)-th image frame of the video to be super-resolved based on the preset selection rule may comprise: firstly, determining each image block with the same position as the image block Bₜ^{j} in the image blocks obtained by decomposing the 1st image frame to the (t−1)-th image frame of the video to be super-resolved, to obtain a second image block set {B₁ⱼ, B₂^{j}, . . . ,Bₜ₋₁^{j}}and then selecting, from the second image block set {B₁^{j}, B₂^{j}, . . . ,Bₜ₋₁^{j}}an image block capable of providing most effective time domain information for the image block Bₜ^{j} as the forward image block corresponding to the image block Bₜ^{j}.

The method further comprises:
S405, obtaining a forward feature of each image block in the plurality of image blocks according to the forward image block pool and the forward feature pool;
S406, obtaining a backward feature of the target image frame according to the backward feature of each image block in the plurality of image blocks;
S407; obtaining a forward feature of the target image frame according to the forward feature of each image block in the plurality of image blocks;
S408, obtaining a super-resolution feature of the target image frame according to the backward feature and the forward feature of the target image frame;
S409, obtaining a super-resolution image frame corresponding to the target image frame according to the super-resolution feature of the target image frame.

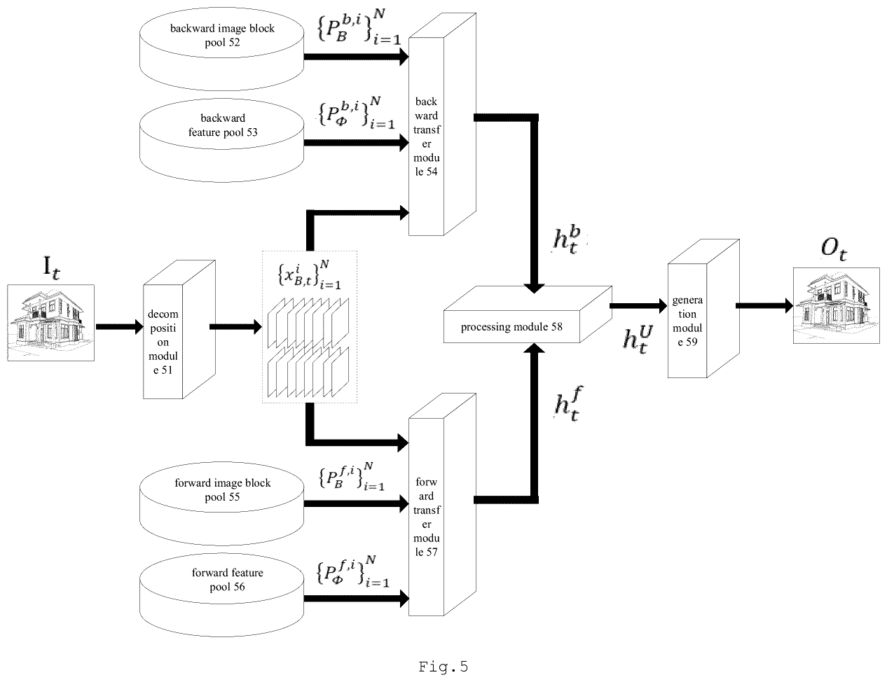

Referring to FIG. 5, FIG. 5 is a schematic structural diagram of a video super-resolution network for implementing the video super-resolution method of FIG. 4. The video super-resolution network for implementing the video super-resolution method of FIG. 4 comprises: a decomposition module 51, a backward image block pool 52, a backward feature pool 53, a backward feature transfer module 54, a forward image block pool 55, a forward feature pool 56, a forward feature transfer module 57, a processing module 58, and a generation module 59.

The decomposition module 51 is configured to decompose a target image frame Iₜ of a video to be super-resolved into a plurality of image blocks {x_{B,t}ⁱ}ᵢ₌₁^{N}. The backward image block pool 52 is configured to store a backward image block {p_{B} ^{b,i}}ᵢ₌₁^{N} corresponding to each image block in the plurality of image blocks; the backward feature pool 53 is configured to store a feature {p_{ϕ}^{b,i}}ᵢ₌₁^{N} of each backward image block; and the backward feature transfer module 54 is configured to obtain a backward feature hₜ^{b} of the target image frame according to the plurality of image blocks {x_{B,t}ⁱ}_{t=1′}^{N}, the backward image block {p_{B}^{b,i}}ᵢ₌₁^{N} in the backward image block pool, and the feature {p_{ϕ}^{b,i}}ᵢ₌₁ ^{N} in the backward feature pool. The forward image block pool 55 is configured to store a forward image block {p_{B}^{f,i}}ᵢ₌₁^{N} corresponding to each image block in the plurality of image blocks; the forward feature pool 56 is configured to store a feature {p_{ϕ}^{f,i}}ᵢ₌₁^{N} of each forward image block; and the forward feature transfer module 57 is configured to obtain a forward feature hₜ^{f} of the target image frame according to the plurality of image blocks {x_{B,t}ⁱ}_{i=1′}^{N} the forward image block {p_{B}^{f,i}}ᵢ₌₁^{N} in the forward image block pool, and the feature {p_{ϕ}^{f,i}}ᵢ₌₁^{N} in the forward feature pool. The processing module 58 is configured to obtain a super-resolution feature hₜ^{U} of the target image frame according to the backward feature hₜ^{b} and the forward feature hₜ^{f} of the target image frame. The generation module 59 is configured to generate a super-resolution image frame Oₜ corresponding to the target image frame according to the super-resolution feature hₜ^{U} of the target image frame.

The implementation principle and technical effect of the video super-resolution method provided in this embodiment are similar to those of the video super-resolution method shown in FIG. 1, and thus are not repeated here.

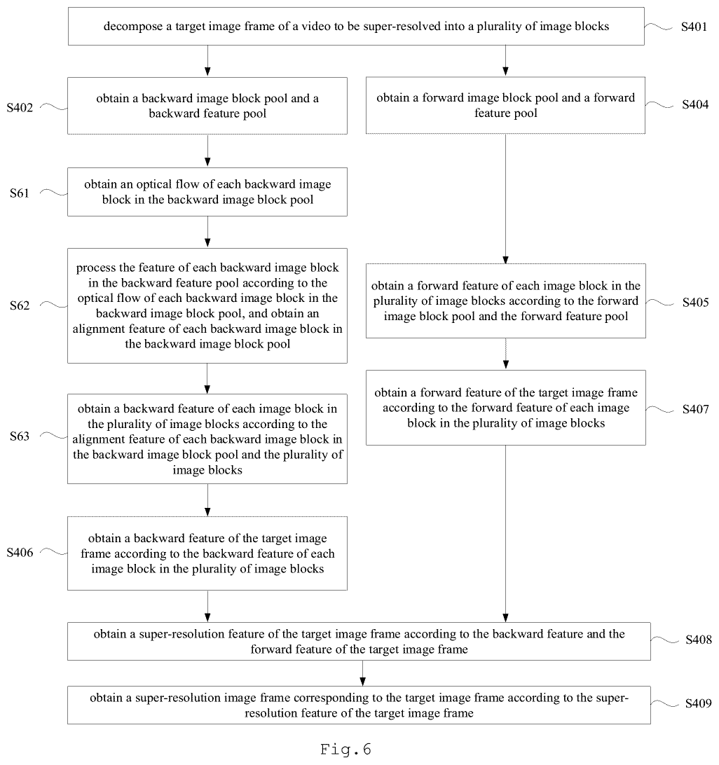

On the basis of the embodiment shown in FIG. 4, referring to FIG. 6, the above step S403 (obtaining a backward feature of each image block in the plurality of image blocks according to the backward image block pool and the backward feature pool) comprises: S61, obtaining an optical flow of each backward image block in the backward image block pool.

An optical flow of any backward image block is an optical flow between the backward image block and an image block corresponding to the backward image block in the plurality of image blocks.

As an optional implementation of the embodiment of the present disclosure, an implementation of the above step S61 (obtaining an optical flow of each backward image block in the backward image block pool) may comprise the following steps 611 and 612:

The method further comprises step 611, generating a first image block sequence according to the plurality of image blocks, and generating a second image block sequence according to the backward image blocks in the backward image block pool.

An order of any image block in the first image block sequence is the same as that of a backward image block corresponding to the image block in the second image block sequence.

In the embodiment of the present disclosure, a ranking order of the plurality of image blocks in the first image block sequence is not limited, and a ranking order of the backward image blocks in the backward image block pool in the second image block is not limited either, subject to an order of any image block in the first image block sequence being the same as that of a backward image block corresponding to the image block in the second image block sequence.

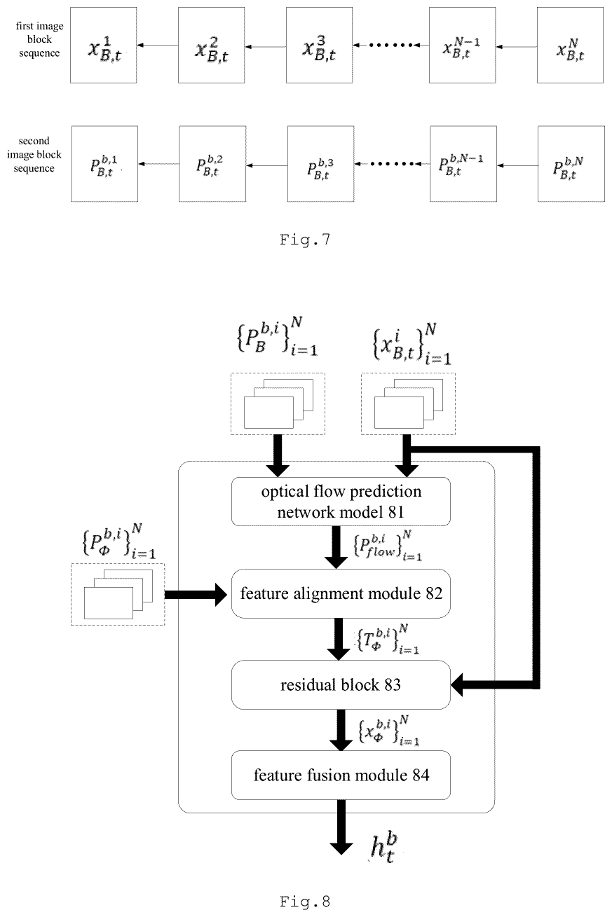

Exemplarily, referring to FIG. 7, a ranking order of the plurality of image blocks {x_{B,t}ⁱ}ᵢ₌₁^{N} in the first image block sequence is: x_{B,t}¹, x_{B,t}², x_{B,t}³, . . . , x_{B,t}^{N-1} [symbol] x_{B,t}^{N}, and a ranking order of the backward image blocks {p_{B}^{b,i}}ᵢ₌₁^{N} in the backward image block pool in the second image block sequence is: p_{B,t}^{b,1}, p_{B,t}^{b,2}, p_{B,t}^{b,3}, . . . , p_{B,t}^{b,N-1}, p_{B,t}^{b,N}, an order of any image block in the plurality of image blocks {x_{B,t}ⁱ}ᵢ₌₁ ⁿ in the first image block sequence being the same as that of a backward image block corresponding to the image block in the second image block sequence.

Step 612, inputting the first image block sequence and the second image block sequence into an optical flow prediction network model, and obtaining an optical flow of each backward image block in the backward image block pool according to an output of the optical flow prediction network model.

S62, processing the feature of each backward image block in the backward feature pool according to the optical flow of each backward image block in the backward image block pool, and obtaining an alignment feature of each backward image block in the backward image block pool.

That is, according to the optical flow of each backward image block in the backward image block pool, the feature of each backward image block in the backward feature pool is aligned with the feature of the corresponding image block in the plurality of image blocks, thereby obtaining the alignment feature of each backward image block in the backward image block pool.

S63, obtaining a backward feature of each image block in the plurality of image blocks according to the alignment feature of each backward image block in the backward image block pool and the plurality of image blocks.

As an optional implementation of the embodiment of the present disclosure, the above step S63 (obtaining a backward feature of each image block in the plurality of image blocks according to the alignment feature of each backward image block in the backward image block pool and the plurality of image blocks) comprises:
processing, by a residual block, each image block in the plurality of image blocks and the alignment feature of the backward image block corresponding to each image block, to obtain the backward feature of each image block in the plurality of image blocks.

Referring to FIG. 8, FIG. 8 is a schematic structural diagram of a backward feature obtaining module for obtaining a backward feature of each image block in the plurality of image blocks according to the backward image block pool and the backward feature pool, and obtaining a backward feature of the target image frame according to the backward feature of each image block in the plurality of image blocks, wherein the backward feature obtaining module comprises: an optical flow prediction network model 81, a feature alignment module 82, a residual block 83, and a feature fusion module 84.

The optical flow prediction network model 81 outputs the optical flow {p_{flow}^{b,i}}ᵢ₌₁^{N} of each backward image block in the backward image block pool according to the inputted backward image blocks {p_{B}^{b,i}}ᵢ₌₁^{N} in the backward image block pool and the plurality of image blocks {x_{B,t}ⁱ}ᵢ₌₁^{N} obtained by decomposing the target image frame of the video to be super-resolved. The feature alignment module 82 is configured to align the feature {p_{ϕ}^{b,i}}ᵢ₌₁^{N} of each backward image block in the backward image block pool with the target image frame according to the optical flow {p_{flow}^{b,i}}ᵢ₌₁^{N} of each backward image block in the backward image block pool, to obtain an alignment feature {T_{ϕ}^{b,i}}ᵢ₌₁^{N} of each backward image block in the backward image block pool. The residual block 83 is configured to obtain a backward feature {x_{ϕ}^{b,i}}ᵢ₌₁^{N} of each image block in the plurality of image blocks according to the alignment feature {T_{ϕ}^{b,i}}ᵢ₌₁^{N} of each backward image block in the backward image block pool and the plurality of image blocks {x_{B,t}ⁱ}ᵢ₌₁^{N}. The feature fusion module 84 is configured to fuse the backward feature {x_{ϕ}^{b,i}}ᵢ₌₁^{N} of each image block in the plurality of image blocks to generate the backward feature hₜ^{b} of the target image frame.

As an optional implementation in the embodiment of the present disclosure, the video super-resolution method provided in the embodiment of the present disclosure further comprises:
updating the backward image block pool and the backward feature pool according to the plurality of image blocks and the backward feature of each image block in the plurality of image blocks.

As an optional implementation of the embodiment of the present disclosure, an implementation of the updating the backward image block pool and the backward feature pool according to the plurality of image blocks and the backward feature of each image block in the plurality of image blocks comprises the following steps 1) and 2):
step 1), determining whether an absolute value of the optical flow of each backward image block in the backward image block pool is greater than a preset threshold; and
in response to that an absolute value of an optical flow of a first backward image block in the backward image block pool is greater than the preset threshold in the above step 1), performing the following step 2), replacing the first backward image block in the backward image block pool with an image block corresponding to the first backward image block in the plurality of image blocks, and replacing a feature of the first backward image block in the backward feature pool with a backward feature of the image block corresponding to the first backward image block in the plurality of image blocks.

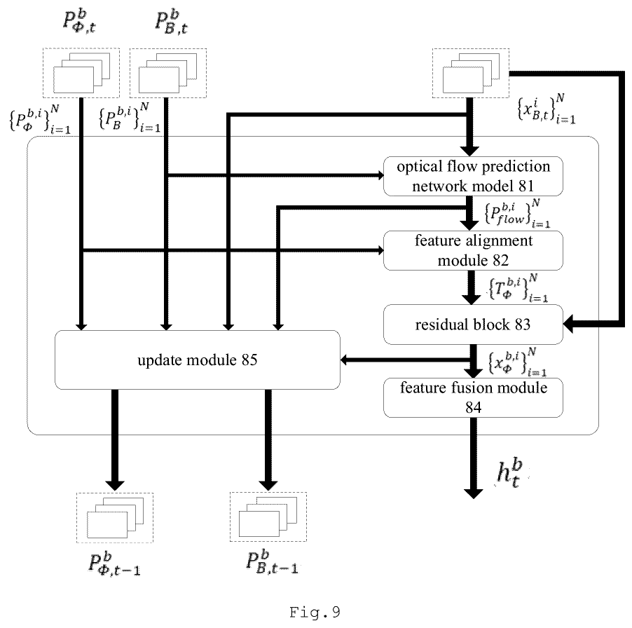

Referring to FIG. 9, FIG. 9 is a schematic structural diagram of the backward feature obtaining module, when the backward feature obtaining module is further configured to update the backward image block pool and the backward feature pool according to the plurality of image blocks and the backward feature of each image block in the plurality of image blocks. The backward feature obtaining module comprises: an optical flow prediction network model 81, a feature alignment module 82, a residual block 83, a feature fusion module 84, and an update module 85.

The optical flow prediction network model 81, the feature alignment module 82, the residual block 83, and the feature fusion module 84 have the same functions as those in FIG. 8, and thus are not repeated here. The update module 85 is configured to update the backward image block pool p_{B,t}^{b} and the backward feature pool p_{ϕ,t}^{b} into a backward image block pool p_{B,t-1} ^{b} and a backward feature pool p_{ϕ,t-1}^{b} according to the plurality of image blocks (x_{B,t}ⁱ)ᵢ₌₁^{N} and the backward feature {x_{ϕ}^{b,i}}ᵢ₌₁^{N} of each image block in the plurality of image blocks, and take the backward image block pool P_{B,t-1} ^{b} and the backward feature pool p_{ϕ,t-1}^{b} as a backward image block pool and a backward feature pool when a previous image frame of the video to be super-resolved is processed.

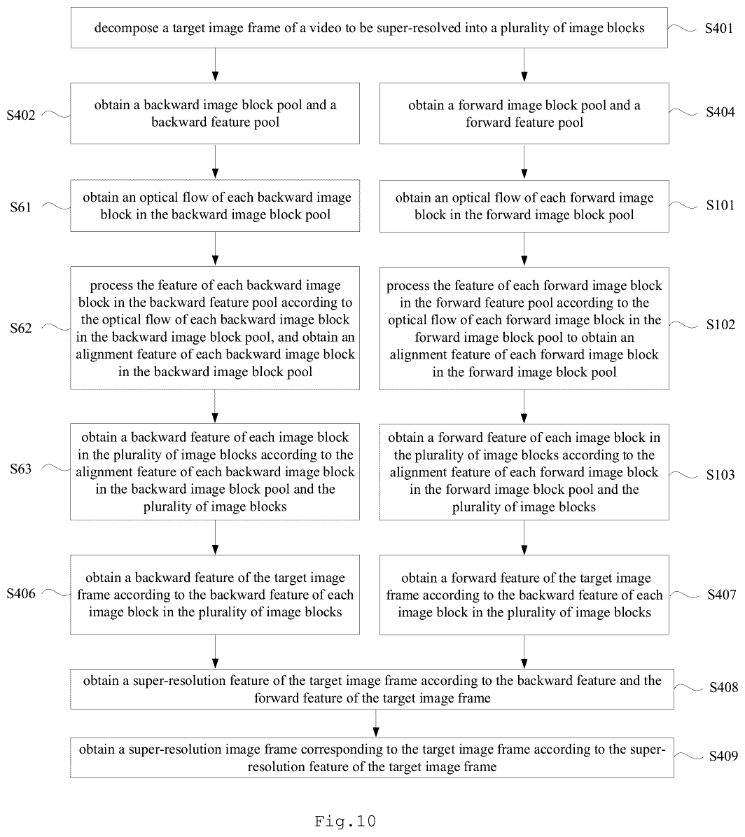

Based on the embodiment shown in FIG. 6, referring to FIG. 10, the above step S405 (obtaining a forward feature of each image block in the plurality of image blocks according to the forward image block pool and the forward feature pool) comprises: S101, obtaining an optical flow of each forward image block in the forward image block pool.

An optical flow of any forward image block is an optical flow between the forward image block and an image block corresponding to the forward image block in the plurality of image blocks.

As an optional implementation of the embodiment of the present disclosure, an implementation of the above step S81 (obtaining an optical flow of each forward image block in the forward image block pool) may comprise the following steps 1011 and 1012:
step 1011, generating a third image block sequence according to the plurality of image blocks, and generating a fourth image block sequence according to the forward image blocks in the forward image block pool.

An order of any image block in the third image block sequence is the same as that of a forward image block corresponding to the image block in the fourth image block sequence.

In the embodiment of the present disclosure, a ranking order of the plurality of image blocks in the third image block sequence is not limited, nor is a ranking order of the forward image blocks in the forward image block pool in the fourth image block, subject to an order of any image block in the third image block sequence being the same as that of a forward image block corresponding to the image block in the fourth image block sequence.

Exemplarily, referring to FIG. 11, a ranking order of the plurality of image blocks {x_{B,t}ⁱ}ᵢ₌₁^{N} in the third image block sequence is: x_{B,t}¹, x_{B,t}², x_{B,t}³, . . . , x_{B,t}^{N-1}, x_{B,t}^{N}, and a ranking order of the forward image blocks {P_{B}^{f,i}}ᵢ₌₁^{N}, in the forward image block pool in the fourth image block sequence is: p_{B,t}^{f,1}, p_{B,t}^{f,2}, p_{B,t}^{f,3}, . . . , p_{B,t}^{f,N-1}, p_{B,t}^{f,N}, an order of any image block of the plurality of image blocks {x_{B,t}ⁱ}ᵢ₌₁^{N} in the third image block sequence being the same as that of a forward image block corresponding to the image block in the fourth image block sequence.

Step 1012, inputting the third image block sequence and the fourth image block sequence into an optical flow prediction network model, and obtaining the optical flow of each forward image block in the forward image block pool according to an output of the optical flow prediction network model.

S102, processing the feature of each forward image block in the forward feature pool according to the optical flow of each forward image block in the forward image block pool, to obtain an alignment feature of each forward image block in the forward image block pool.

That is, according to the optical flow of each forward image block in the forward image block pool, the feature of each forward image block in the forward feature pool is aligned with the feature of the corresponding image block in the plurality of image blocks, thereby obtaining the alignment feature of each forward image block in the forward image block pool.

S103, obtaining a forward feature of each image block in the plurality of image blocks according to the alignment feature of each forward image block in the forward image block pool and the plurality of image blocks.

As an optional implementation of the embodiment of the present disclosure, the above step S83 (obtaining a forward feature of each image block in the plurality of image blocks according to the alignment feature of each forward image block in the forward image block pool and the plurality of image blocks) comprises:
processing, by a residual block, each image block in the plurality of image blocks and the alignment feature of the forward image block corresponding to each image block, to obtain the forward feature of each image block in the plurality of image blocks.

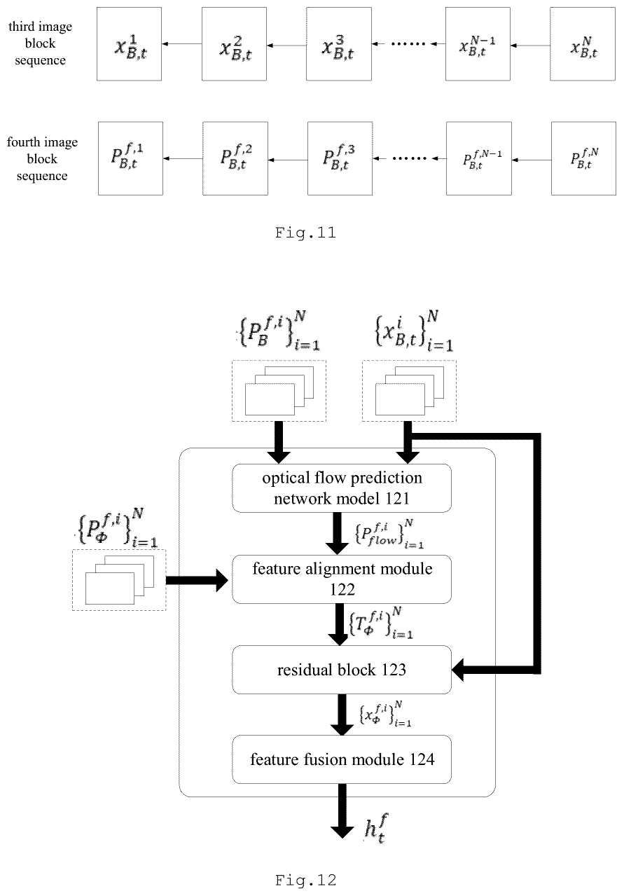

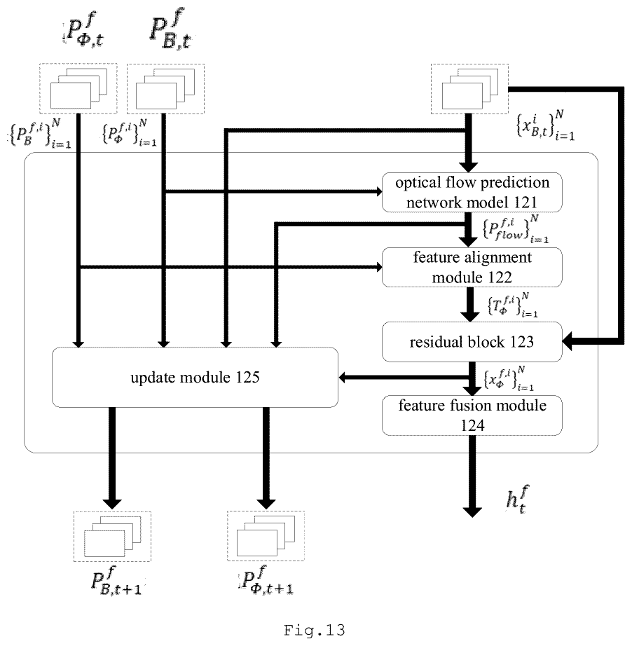

Referring to FIG. 12, FIG. 12 is a schematic structural diagram of a forward feature obtaining module for obtaining a forward feature of each image block in the plurality of image blocks according to the forward image block pool and the forward feature pool, and obtaining a forward feature of the target image frame according to the forward feature of each image block in the plurality of image blocks, wherein the forward feature obtaining module comprises: an optical flow prediction network model 121, a feature alignment module 122, a residual block 123, and a feature fusion module 124.

The optical flow prediction network model 121 outputs an optical flow {P_{flow}^{f,i}}ᵢ₌₁^{N} of each forward image block in the forward image block pool according to the inputted forward image blocks {p_{B}^{f,i}}ᵢ₌₁^{N} in the forward image block pool and the plurality of image blocks {x_{B,t}ⁱ}ᵢ₌₁^{N} obtained by decomposing the target image frame of the video to be super-resolved. The feature alignment module 122 is configured to align the feature {p_{ϕ}^{f,i}}ᵢ₌₁^{N} of each forward image block in the forward image block pool with the target image frame according to the optical flow {p_{flow}^{f,i}}ᵢ₌₁^{N} of each forward image block in the forward image block pool, to obtain the alignment feature {T_{ϕ}^{f,i}}ᵢ₌₁^{N} of each forward image block in the forward image block pool. The residual block 123 is configured to obtain a forward feature {x_{ϕ}^{f,i}}ᵢ₌₁^{N} of each image block in the plurality of image blocks according to the alignment feature {T_{ϕ}^{f,i}}ᵢ₌₁^{N} of each forward image block in the forward image block pool and the plurality of image blocks {x_{B,t}ⁱ}ᵢ₌₁^{N}. The feature fusion module 124 is configured to fuse the forward feature {x_{ϕ}^{f,i}}ᵢ₌₁^{N} of each image block in the plurality of image blocks to generate a forward feature hₜ^{f} of the target image frame.

As an optional implementation of the embodiment of the present disclosure, the video super-resolution method provided in the embodiment of the present disclosure further comprises:
updating the forward image block pool and the forward feature pool according to the plurality of image blocks and the forward feature of each image block in the plurality of image blocks.

As an optional implementation of the embodiment of the present disclosure, an implementation of the updating the forward image block pool and the forward feature pool according to the plurality of image blocks and the forward feature of each image block in the plurality of image blocks comprises the following steps I and II:
step I, determining whether an absolute value of the optical flow of each forward image block in the forward image block pool is greater than a preset threshold; and
in the above step I, in response to that an absolute value of an optical flow of a first forward image block in the forward image block pool is greater than the preset threshold, performing the following step II, replacing the first forward image block in the forward image block pool with an image block corresponding to the first forward image block in the plurality of image blocks, and replacing a feature of the first forward image block in the forward feature pool with a forward feature of the image block corresponding to the first forward image block in the plurality of image blocks.

Referring to FIG. 13, FIG. 13 is a schematic structural diagram of the forward feature obtaining module, when the forward feature obtaining module is further configured to update the forward image block pool and the forward feature pool according to the plurality of image blocks and the forward feature of each image block in the plurality of image blocks. The forward feature obtaining module comprises: an optical flow prediction network model 121, a feature alignment module 122, a residual block 123, a feature fusion module 124, and an update module 125.

The functions of the optical flow prediction network model 121, the feature alignment module 122, the residual block 123 and the feature fusion module 124 are the same as those in FIG. 12, and thus are not repeated here. The update module 125 is configured to update the forward image block pool P_{B,t}^{f} and the forward feature pool P_{ϕ,t}^{f} into a forward image block pool p_{B,t+1}^{f} and a forward feature pool p_{ϕ,t+1}^{f} according to the plurality of image blocks {x_{B,t}ⁱ}ᵢ₌₁^{N} and the forward feature {x_{ϕ}^{f,i}}ᵢ₌₁^{N} of each image block in the plurality of image blocks, and take the forward image block pool p_{B,t+1}^{f} and the forward feature pool p_{ϕ,t+1}^{f} as a forward image block pool and a forward feature pool when a next image frame of the video to be super-resolved is processed.

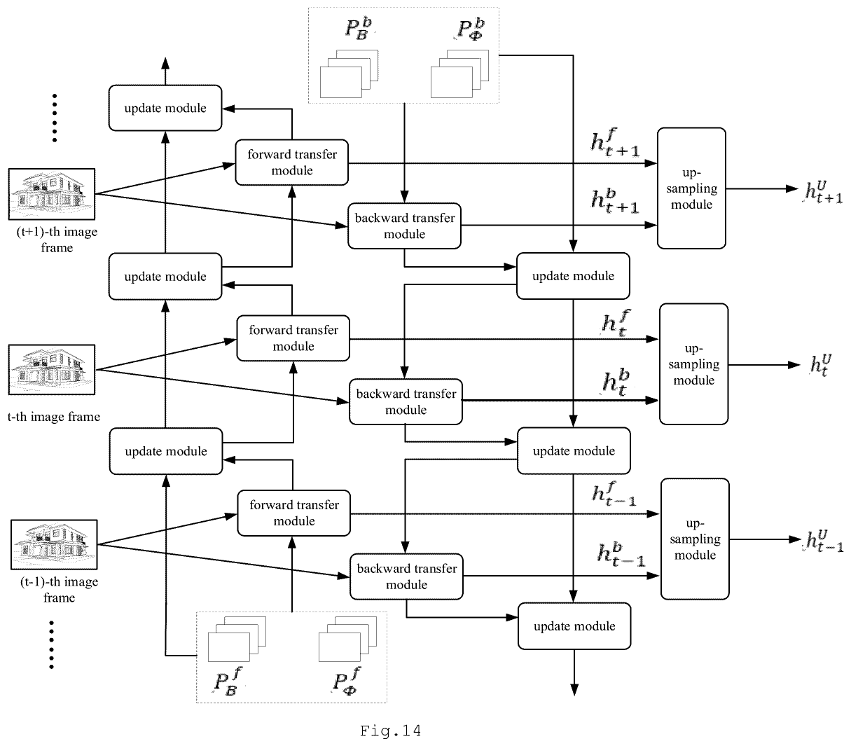

Further, referring to FIG. 14, FIG. 14 is a network structure diagram of a video super-resolution network according to an embodiment of the present disclosure. Referring to FIG. 14, a target image frame of a video to be super-resolved is super-resolved by using a backward image block pool p_{B}^{b} and a backward feature pool p_{ϕ}^{b} updated by a (t+1) -th image frame and a forward image block pool p_{B} ^{f} and a forward feature pool P_{ϕ}^{f} updated by a (t−1)-th image frame, and the backward image block pool p_{B} ^{f} and the backward feature pool P_{ϕ}^{f} are updated again, and the backward image block pool p_{B}^{f} and the backward feature pool p_{ϕ}^{f} after updated by the target image frame are taken as a backward image block pool p_{B}^{f} and backward feature pool Pf of a next image frame (the (t+1)th image frame), and the forward image block pool p_{B}^{f} and forward feature pool p_{B}^{f} after updated by the target image frame are taken as a forward image block pool p_{B} ^{f} and forward feature pool p_{ϕ}^{f} of a previous image frame (the (t−1)th image frame).

Based on the same inventive concept, as an implementation of the above method, an embodiment of the present disclosure further provides a video super-resolution apparatus; the apparatus embodiment corresponds to the foregoing method embodiment, and for convenience of reading, details in the foregoing method embodiment are not repeated in this apparatus embodiment one by one, but it should be clear that the video super-resolution apparatus in this embodiment can correspondingly implement all contents in the foregoing method embodiment.

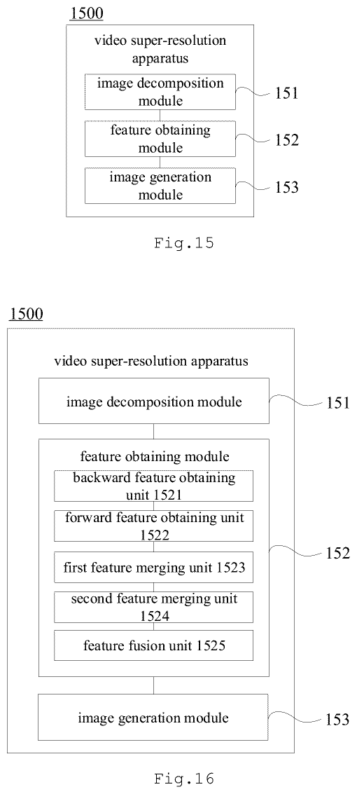

An embodiment of the present disclosure provides a video super-resolution apparatus. FIG. 15 is a schematic structural diagram of the video super-resolution apparatus, as shown in FIG. 15, the video super-resolution apparatus 1500 comprising:
an image decompositionmodule 151, configured to decompose a target image frame of a video to be super-resolved into a plurality of image blocks;
a feature obtaining module 152, configured to obtain a super-resolution feature of the target image frame according to the plurality of image blocks and image blocks obtained by decomposing other image frames in the video to be super-resolved; and
an image generation module 153, configured to obtain a super-resolution image frame corresponding to the target image frame according to the super-resolution feature of the target image frame.

As an optional implementation of the embodiment of the present disclosure, referring to FIG. 16, the feature obtaining module 152 comprises:
a backward feature obtaining unit 1521, configured to obtain a backward feature of each image block in the plurality of image blocks, a backward feature of any image block being a feature of an image block corresponding to the image block in image blocks obtained by decomposing image frames located after the target image frame in the video to be super-resolved;
a forward feature obtaining unit 1522, configured to obtain a forward feature of each image block in the plurality of image blocks, a forward feature of any image block being a feature of an image block corresponding to the image block in image blocks obtained by decomposing image frames located before the target image frame in the video to be super-resolved;
a first feature merging unit 1523, configured to obtain a backward feature of the target image frame according to the backward feature of each image block in the plurality of image blocks;
a second feature merging unit 1524, configured to obtain a forward feature of the target image frame according to the forward feature of each image block in the plurality of image blocks;
a feature fusion unit 1525, configured to obtain the super-resolution feature of the target image frame according to the backward feature and the forward feature of the target image frame.

As an optional implementation of the embodiment of the present disclosure, the backward feature obtaining unit 1521 is specifically configured to obtain a backward image block pool and a backward feature pool, the backward image block pool comprising a backward image block corresponding to each image block in the plurality of image blocks; a backward image block corresponding to any image block being an image block selected from the image blocks obtained by decomposing image frames located after the target image frame in the video to be super-resolved based on a preset selection rule; the backward feature pool comprising a feature of each backward image block in the backward image block pool; and obtain the backward feature of each image block in the plurality of image blocks according to the backward image block pool and the backward feature pool.

As an optional implementation of the embodiment of the present disclosure, the backward feature obtaining unit 1521 is specifically configured to obtain an optical flow of each backward image block in the backward image block pool, an optical flow of any backward image block being an optical flow between the backward image block and an image block corresponding to the backward image block in the plurality of image blocks; process the feature of each backward image block in the backward feature pool according to the optical flow of each backward image block in the backward image block pool to obtain an alignment feature of each backward image block in the backward image block pool; and obtain the backward feature of each image block in the plurality of image blocks according to the alignment feature of each backward image block in the backward image block pool and the plurality of image blocks.

As an optional implementation of the embodiment of the present disclosure, the backward feature obtaining unit 1521 is specifically configured to generate a first image block sequence according to the plurality of image blocks, and generate a second image block sequence according to the backward image blocks in the backward image block pool, an order of any image block in the first image block sequence being the same as that of a backward image block corresponding to the image block in the second image block sequence; and input the first image block sequence and the second image block sequence into an optical flow prediction network model, and obtain the optical flow of each backward image block in the backward image block pool according to an output of the optical flow prediction network model.

As an optional implementation of the embodiment of the present disclosure, the backward feature obtaining unit 1521 is specifically configured to process, by a residual block, each image block in the plurality of image blocks and the alignment feature of the backward image block corresponding to each image block to obtain the backward feature of each image block in the plurality of image blocks.

As an optional implementation of the embodiment of the present disclosure, the backward feature obtaining unit 1521 is further configured to update the backward image block pool and the backward feature pool according to the plurality of image blocks and the backward feature of each image block in the plurality of image blocks.

As an optional implementation of the embodiment of the present disclosure, the backward feature obtaining unit 1521 is specifically configured to determine whether an absolute value of the optical flow of each backward image block in the backward image block pool is greater than a preset threshold; and in response to that an absolute value of an optical flow of a first backward image block in the backward image block pool is greater than the preset threshold, replace the first backward image block in the backward image block pool with an image block corresponding to the first backward image block in the plurality of image blocks, and replace a feature of the first backward image block in the backward feature pool with a backward feature of the image block corresponding to the first backward image block in the plurality of image blocks.

As an optional implementation of the embodiment of the present disclosure, the forward feature obtaining unit 1522 is specifically configured to obtain a forward image block pool and a forward feature pool, the forward image block pool comprising a forward image block corresponding to each image block in the plurality of image blocks, a forward image block corresponding to any image block being an image block selected from image blocks obtained by decomposing image frames located before the target image frame in the video to be super-resolved based on the preset selection rule, the forward feature pool comprising a feature of each forward image block in the forward image block pool; and obtain a forward feature of each image block in the plurality of image blocks according to the forward image block pool and the forward feature pool.

As an optional implementation of the embodiment of the present disclosure, the forward feature obtaining unit 1522 is specifically configured to obtain an optical flow of each forward image block in the forward image block pool, an optical flow of any forward image block being an optical flow between the forward image block and an image block corresponding to the forward image block in the plurality of image blocks; process the feature of each forward image block in the forward feature pool according to the optical flow of each forward image block in the forward image block pool to obtain an alignment feature of each forward image block in the forward image block pool; and obtain the forward feature of each image block in the plurality of image blocks according to the alignment feature of each forward image block in the forward image block pool and the plurality of image blocks.

As an optional implementation of the embodiment of the present disclosure, the forward feature obtaining unit 1522 is specifically configured to generate a third image block sequence according to the plurality of image blocks, and generate a fourth image block sequence according to the forward image blocks in the forward image block pool, an order of any image block in the third image block sequence being the same as that of a forward image block corresponding to the image block in the fourth image block sequence; input the third image block sequence and the fourth image block sequence into an optical flow prediction network model, and obtain the optical flow of each forward image block in the forward image block pool according to an output of the optical flow prediction network model.

As an optional implementation of the embodiment of the present disclosure, the forward feature obtaining unit 1522 is specifically configured to process, by a residual block, each image block in the plurality of image blocks and the alignment feature of the forward image block corresponding to each image block to obtain the forward feature of each image block in the plurality of image blocks.

As an optional implementation of the embodiment of the present disclosure, the forward feature obtaining unit 1522 is further configured to update the forward image block pool and the forward feature pool according to the plurality of image blocks and the forward feature of each image block in the plurality of image blocks.

As an optional implementation of the embodiment of the present disclosure, the forward feature obtaining unit 1522 is specifically configured to determine whether an absolute value of the optical flow of each forward image block in the forward image block pool is greater than a preset threshold; and in response to that an absolute value of an optical flow of a first forward image block in the forward image block pool is greater than the preset threshold, replace the first forward image block in the forward image block pool with an image block corresponding to the first forward image block in the plurality of image blocks, and replace a feature of the first forward image block in the forward feature pool with a forward feature of the image block corresponding to the first forward image block in the plurality of image blocks.

As an optional implementation of the embodiment of the present disclosure, the feature processing unit 153 is specifically configured to merge the backward feature and the forward feature of the target image frame to obtain a merged feature of the target image frame; and up-sample the merged feature of the target image frame to obtain the super-resolution feature of the target image frame.

The video super-resolution apparatus provided by this embodiment may perform the video super-resolution method provided in the above method embodiment, and has the similar implementation principle and technical effect, which are not repeated here.

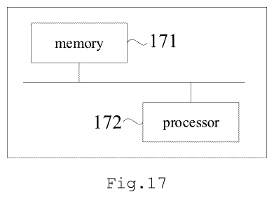

Based on the same inventive concept, an embodiment of the present disclosure further provides an electronic device. FIG. 17 is a schematic structural diagram of an electronic device according to an embodiment of the present disclosure, as shown in FIG. 17, the electronic device provided in the embodiment comprising: a memory 171 and a processor 172, the memory 171 being configured to store a computer program, and the processor 172 being configured to perform, when calling the computer program, the video super-resolution method provided in the above embodiment.

Based on the same inventive concept, an embodiment of the present disclosure further provides a computer-readable storage medium having thereon stored a computer program which, when executed by a processor, causes the computing device to implement the video super-resolution method provided in the above embodiment.

Based on the same inventive concept, an embodiment of the present disclosure further provides a computer program product which, when run on a computer, causes the computing device to implement the video super-resolution method provided in the above embodiment.

It should be appreciated by those skilled in the art that, the embodiments of the present disclosure may be provided as a method, system, or computer program product. Therefore, the present disclosure may take a form of an entire hardware embodiment, an entire software embodiment, or an embodiment combining software and hardware aspects. Moreover, the present disclosure may take a form of a computer program product implemented on one or more computer-usable storage media having computer-usable program code embodied therein.

The processor may be a central processing unit (CPU), or another general purpose processor, a digital signal processor (DSP), an application specific integrated circuit (ASIC), a field-programmable gate array (FPGA) or other programmable logic device, a discrete gate or transistor logic device, a discrete hardware component, etc. The general purpose processor may be a microprocessor, or the processor may also be any conventional processor, etc.

The memory may include a non-permanent memory in a computer-readable medium, such as a random access memory (RAM), and/or anon-volatile memory, such as a read-onlymemory (ROM) or flash memory (flash RAM). The memory is an example of the computer-readable medium.

The computer-readable medium comprises permanent and non-permanent, removable and non-removable storage media. The storage medium may implement storage of information by any method or technology, wherein the information may be computer-readable instructions, data structures, modules of a program, or other data. Examples of a storage medium of a computer include, but are not limited to, a phase change memory (PRAM), static random access memory (SRAM), dynamic random access memory (DRAM), other type of random access memory (RAM), read-only memory (ROM), electrically erasable programmable read-only memory (EEPROM), flash memory or other memory technology, compact disc read-only memory (CD-ROM), digital versatile disks (DVD) or other optical storage, magnetic cassette, magnetic disk storage or other magnetic storage device, or any other non-transmission medium, which can be used for storing information that can be accessed by a computing device. As defined herein, the computer-readable medium does not include transitory media such as modulated data signals and carriers.

Finally, it should be noted that: the above embodiments are only used for illustrating the technical solutions of the present disclosure, and not for limiting the same; although the detailed description of the present disclosure has been made with reference to the foregoing embodiments, those of ordinary skill in the art should understand that: they may still modify the technical solutions described in the foregoing embodiments or equivalently substitute some or all of the technical features thereof; and these modifications or substitutions do not make the essence of the corresponding technical solutions depart from the scope of the technical solutions of the embodiments of the present disclosure.

1. A video super-resolution method, comprising:
decomposing a target image frame of a video to be super-resolved into a plurality of image blocks;
obtaining a super-resolution feature of the target image frame according to the plurality of image blocks and image blocks obtained by decomposing other image frames in the video to be super-resolved; and
obtaining a super-resolution image frame corresponding to the target image frame according to the super-resolution feature of the target image frame according to the super-resolution feature of the target image frame.

2. The video super-resolution method according to claim 1, wherein the obtaining a super-resolution feature of the target image frame according to the plurality of image blocks and image blocks obtained by decomposing other image frames in the video to be super-resolved, comprises:
obtaining a backward feature of each image block in the plurality of image blocks, wherein a backward feature of any image block is a feature of an image block corresponding to the image block in image blocks obtained by decomposing image frames located after the target image frame in the video to be super-resolved;
obtaining a forward feature of each image block in the plurality of image blocks, wherein a forward feature of any image block is a feature of an image block corresponding to the image block in image blocks obtained by decomposing image frames located before the target image frame in the video to be super-resolved;
obtaining a backward feature of the target image frame according to the backward feature of each image block in the plurality of image blocks;
obtaining a forward feature of the target image frame according to the forward feature of each image block in the plurality of image blocks; and
obtaining the super-resolution feature of the target image frame according to the backward feature and the forward feature of the target image frame.

3. The video super-resolution method according to claim 2, wherein the obtaining a backward feature of each image block in the plurality of image blocks, comprises:
obtaining a backward image block pool and a backward feature pool, wherein the backward image block pool comprises a backward image block corresponding to each image block in the plurality of image blocks, a backward image block corresponding to any image block is an image block selected from the image blocks obtained by decomposing the image frames located after the target image frame in the video to be super-resolved based on a preset selection rule, and the backward feature pool comprises a feature of each backward image block in the backward image block pool; and
obtaining the backward feature of each image block in the plurality of image blocks according to the backward image block pool and the backward feature pool.

4. The video super-resolution method according to claim 3, wherein the obtaining the backward feature of each image block in the plurality of image blocks according to the backward image block pool and the backward feature pool, comprises:
obtaining an optical flow of each backward image block in the backward image block pool, wherein an optical flow of any backward image block is an optical flow between the backward image block and an image block corresponding to the backward image block in the plurality of image blocks;
processing the feature of each backward image block in the backward feature pool according to the optical flow of each backward image block in the backward image block pool, to obtain an alignment feature of each backward image block in the backward image block pool; and
obtaining the backward feature of each image block in the plurality of image blocks according to the alignment feature of each backward image block in the backward image block pool and the plurality of image blocks.

5. The video super-resolution method according to claim 4, wherein the obtaining an optical flow of each backward image block in the backward image block pool, comprises:
generating a first image block sequence according to the plurality of image blocks, and generating a second image block sequence according to the backward image blocks in the backward image block pool, wherein an order of any image block in the first image block sequence is the same as that of a backward image block corresponding to the image block in the second image block sequence;
inputting the first image block sequence and the second image block sequence into an optical flow prediction network model, and obtaining the optical flow of each backward image block in the backward image block pool according to an output of the optical flow prediction network model.

6. The video super-resolution method according to claim 4,
wherein the obtaining the backward feature of each image block in the plurality of image blocks according to the alignment feature of each backward image block in the backward image block pool and the plurality of image blocks, comprises:
processing, by a residual block, each image block in the plurality of image blocks and the alignment feature of the backward image block corresponding to each image block, to obtain the backward feature of each image block in the plurality of image blocks.

7. The video super-resolution method according to claim 3, further comprising:
updating the backward image block pool and the backward feature pool according to the plurality of image blocks and the backward feature of each image block in the plurality of image blocks.

8. The video super-resolution method according to claim 7, wherein the updating the backward image block pool and the backward feature pool according to the plurality of image blocks and the backward feature of each image block in the plurality of image blocks, comprises:
determining whether an absolute value of the optical flow of each backward image block in the backward image block pool is greater than a preset threshold; and
in response to an absolute value of an optical flow of a first backward image block in the backward image block pool being greater than the preset threshold, replacing the first backward image block in the backward image block pool with an image block corresponding to the first backward image block in the plurality of image blocks, and replacing a feature of the first backward image block in the backward feature pool with a backward feature of the image block corresponding to the first backward image block in the plurality of image blocks.

9. The video super-resolution method according to claim 2, wherein the obtaining a forward feature of each image block in the plurality of image blocks, comprises:
obtaining a forward image block pool and a forward feature pool, wherein the forward image block pool comprises a forward image block corresponding to each image block in the plurality of image blocks, a forward image block corresponding to any image block is an image block selected from the image blocks obtained by decomposing the image frames located before the target image frame in the video to be super-resolved based on the preset selection rule, and the forward feature pool comprises a feature of each forward image block in the forward image block pool; and
obtaining the forward feature of each image block in the plurality of image blocks according to the forward image block pool and the forward feature pool.

10. The video super-resolution method according to claim 9, wherein the obtaining the forward feature of each image block in the plurality of image blocks according to the forward image block pool and the forward feature pool, comprises:
obtaining an optical flow of each forward image block in the forward image block pool, wherein an optical flow of any forward image block is an optical flow between the forward image block and an image block corresponding to the forward image block in the plurality of image blocks;
processing the feature of each forward image block in the forward feature pool according to the optical flow of each forward image block in the forward image block pool, to obtain an alignment feature of each forward image block in the forward image block pool; and
obtaining the forward feature of each image block in the plurality of image blocks according to the alignment feature of each forward image block in the forward image block pool and the plurality of image blocks.

11. The video super-resolution method according to claim 10, wherein the obtaining an optical flow of each forward image block in the forward image block pool, comprises:
generating a third image block sequence according to the plurality of image blocks, and generating a fourth image block sequence according to the forward image blocks in the forward image block pool, wherein an order of any image block in the third image block sequence is the same as that of a forward image block corresponding to the image block in the fourth image block sequence;
inputting the third image block sequence and the fourth image block sequence into an optical flow prediction network model, and obtaining the optical flow of each forward image block in the forward image block pool according to an output of the optical flow prediction network model.

12. The video super-resolution method according to claim 10,
wherein the obtaining the forward feature of each image block in the plurality of image blocks according to the alignment feature of each forward image block in the forward image block pool and the plurality of image blocks, comprises:
processing, by a residual block, each image block in the plurality of image blocks and the alignment feature of the forward image block corresponding to each image block, to obtain the forward feature of each image block in the plurality of image blocks.

13. The video super-resolution method according to claim 9, further comprising:
updating the forward image block pool and the forward feature pool according to the plurality of image blocks and the forward feature of each image block in the plurality of image blocks.

14. The video super-resolution method according to claim 13, wherein the updating the forward image block pool and the forward feature pool according to the plurality of image blocks and the forward feature of each image block in the plurality of image blocks, comprises:
determining whether an absolute value of the optical flow of each forward image block in the forward image block pool is greater than a preset threshold; and
in response to an absolute value of an optical flow of a first forward image block in the forward image block pool being greater than the preset threshold, replacing the first forward image block in the forward image block pool with an image block corresponding to the first forward image block in the plurality of image blocks, and replacing a feature of the first forward image block in the forward feature pool with a forward feature of the image block corresponding to the first forward image block in the plurality of image blocks.

15. The video super-resolution method according to claim 2, wherein the obtaining the super-resolution feature of the target image frame according to the backward feature and the forward feature of the target image frame, comprises:
merging the backward feature and the forward feature of the target image frame to obtain a merged feature of the target image frame; and
up-sampling the merged feature of the target image frame to obtain the super-resolution feature of the target image frame.

16. (canceled)

17. An electronic device, comprising:
a memory and a processor,
the memory being configured to store instructions; and
the processor being configured to, when executing the instructions, cause the electronic device to implement a video super-resolution method comprising:
decomposing a target image frame of a video to be super-resolved into a plurality of image blocks;
obtaining a super-resolution feature of the target image frame according to the plurality of image blocks and image blocks obtained by decomposing other image frames in the video to be super-resolved; and
obtaining a super-resolution image frame corresponding to the target image frame according to the super-resolution feature of the target image frame according to the super-resolution feature of the target image frame.

18. A non-transitory computer-readable storage medium having thereon stored instructions which, when executed by a processor, implement thea_video super-resolution method comprising:
decomposing a target image frame of a video to be super-resolved into a plurality of image blocks;
obtaining a super-resolution feature of the target image frame according to the plurality of image blocks and image blocks obtained by decomposing other image frames in the video to be super-resolved; and
obtaining a super-resolution image frame corresponding to the target image frame according to the super-resolution feature of the target image frame according to the super-resolution feature of the target image frame.

19-20. (canceled)

21. The electronic device according to claim 17, wherein the obtaining a super-resolution feature of the target image frame according to the plurality of image blocks and image blocks obtained by decomposing other image frames in the video to be super-resolved, comprises:
obtaining a backward feature of each image block in the plurality of image blocks, wherein a backward feature of any image block is a feature of an image block corresponding to the image block in image blocks obtained by decomposing image frames located after the target image frame in the video to be super-resolved;
obtaining a forward feature of each image block in the plurality of image blocks, wherein a forward feature of any image block is a feature of an image block corresponding to the image block in image blocks obtained by decomposing image frames located before the target image frame in the video to be super-resolved;
obtaining a backward feature of the target image frame according to the backward feature of each image block in the plurality of image blocks;
obtaining a forward feature of the target image frame according to the forward feature of each image block in the plurality of image blocks; and
obtaining the super-resolution feature of the target image frame according to the backward feature and the forward feature of the target image frame.

22. The non-transitory computer-readable storage medium according to claim 18, wherein the obtaining a super-resolution feature of the target image frame according to the plurality of image blocks and image blocks obtained by decomposing other image frames in the video to be super-resolved, comprises:
obtaining a backward feature of each image block in the plurality of image blocks, wherein a backward feature of any image block is a feature of an image block corresponding to the image block in image blocks obtained by decomposing image frames located after the target image frame in the video to be super-resolved;
obtaining a forward feature of each image block in the plurality of image blocks, wherein a forward feature of any image block is a feature of an image block corresponding to the image block in image blocks obtained by decomposing image frames located before the target image frame in the video to be super-resolved;
obtaining a backward feature of the target image frame according to the backward feature of each image block in the plurality of image blocks;
obtaining a forward feature of the target image frame according to the forward feature of each image block in the plurality of image blocks; and
obtaining the super-resolution feature of the target image frame according to the backward feature and the forward feature of the target image frame.
